(19) United States
(12) Patent Application Publication
(10) Pub. No.: US 2016/0355430 A1
(43) Pub. Date: Dec. 8, 2016

(54) GLASS FOR CHEMICAL STRENGTHENING, CHEMICALLY-STRENGTHENED GLASS, AND METHOD FOR PRODUCING CHEMICALLY-STRENGTHENED GLASS

(71) Applicant: Asahi Glass Company, Limited, Chiyoda-ku (JP)

(72) Inventors: Shuji YAMAZAKI, Tokyo (JP); Akio Koike, Tokyo (JP); Junichiro Kase, Tokyo (JP); Shusaku Akiba, Tokyo (JP); Junko Miyasaka, Tokyo (JP); Seiki Ohara, Tokyo (JP)

(73) Assignee: Asahi Glass Company, Limited, Chiyoda-ku (JP)

(21) Appl. No.: 15/179,067

(22) Filed: Jun. 10, 2016

Related U.S. Application Data
(63) Continuation of application No. PCT/JP2014/083007, filed on Dec. 12, 2014.

(30) Foreign Application Priority Data
Dec. 13, 2013 (JP) 2013-258465
Feb. 7, 2014 (JP) 2014-022725
Mar. 28, 2014 (JP) 2014-070099

(51) Int. Cl. C03C 3/087; C03C 21/00; C03C 4/18

(52) U.S. Cl. CPC C03C 3/087; C03C 4/18; C03C 21/002; C03C 2204/00

(57) ABSTRACT

A glass is a glass sheet containing, as expressed by mass percentage based on oxides, 63 to 75% of SiO₂, 3 to 12% of Al₂O₃, 3 to 10% of MgO, 0.5 to 10% of CaO, 0 to 3% of SrO, 0 to 3% of BaO, 10 to 18% of Na₂O, 0 to 8% of K₂O, 0 to 3% of ZrO₂, and 0.005 to 0.25% of Fe₂O₃. The glass has a temperature (T2) at which a viscosity thereof reaches 10² dPa·s of 1525° C. or lower. In the glass, R₂O/Al₂O₃ is 2.0 or more and 4.6 or less (in the formula, the R₂O is Na₂O+K₂O).

### TECHNICAL FIELD

The present invention relates to a glass for chemical strengthening, favorable as a raw sheet glass for a chemically strengthened glass that is used in a cover glass and a touch sensor glass of a touch panel display equipped in information instruments such as tablet PCs, notebook-size PCs, smartphones, e-book readers, etc., a cover glass of liquid-crystal televisions, PC monitors, etc., a cover glass for solar cells, and a multilayer glass for use in windows of buildings and houses, etc., to a chemically strengthened glass using the glass for chemical strengthening, and to a method for producing the chemically strengthened glass.

### BACKGROUND ART

Recently, as for information instruments, ones equipped with a touch panel display have been becoming mainstream, as seen in tablet PCs, smartphones, e-book readers, etc. A touch panel display has a structure where a touch sensor glass and a cover glass are layered on a glass substrate for display. There is also known an integrated configuration of a touch sensor glass and a cover glass, which is called OGS (one glass solution).

In a touch sensor glass, a cover glass and an OGS glass, any glass is desired to be thin and have a high strength, for which a glass that has been chemically strengthened through ion exchange, that is, a chemically strengthened glass is used.

The strength characteristics of these chemically strengthened glasses are generally expressed as a surface compressive stress (CS, compressive stress) and a depth of compressive stress (DOL, depth of layer). In the case where a raw sheet glass of ordinary soda lime glass is subjected to chemical strengthening treatment, in general, a chemically strengthened glass having CS of 500 to 600 MPa and DOL of 6 to 10 μm can be obtained.

There has been proposed an aluminosilicate glass having an easily ion-exchangeable composition for enhancing the strength than in a soda lime glass, and in the case where a raw sheet glass of an aluminosilicate glass is subjected to the same chemical strengthening treatment, there can be obtained a chemically strengthened glass having CS of 700 to 850 MPa and DOL of 20 to 100 μm.

For example, a glass composition containing, as expressed in terms of % by mass, SiO₂: 60 to 64%, Al₂O₃: 8 to 12%, B₂O₃: 0 to 1%, MgO: 6 to 10%, CaO: 0 to 1%, SrO: 1 to 3%, BaO: 0 to 1%, Li₂O: 0 to 1%, Na₂O: 15 to 20%, and K₂O: 0 to 4%, in which MgO+CaO+SrO+BaO falls within a range of 7 to 12%, is disclosed (see PTL 1). In addition, an ion-exchangeable aluminosilicate glass not containing lithium and containing 0.1 to 10 mol % of P₂O₅ and at least 5 mol % of Al₂O₃ is disclosed, which is ion-exchangeable with at least one of sodium, potassium, rubidium, cesium, copper, thallium, and silver and which has a liquidus curve viscosity of at least 100 kpoise (see PTL 2).

### CITATION LIST

### Patent Literature

PTL 1: JP-A2013-193887

PTL 2: JP-T 2013-533838

### SUMMARY OF INVENTION

### Technical Problem

In such an aluminosilicate glass, the amount of Al₂O₃ in the glass is increased for increasing CS and DOL therein. However, Al₂O₃ is a component of increasing the viscosity of glass, and consequently an aluminosilicate glass has a problem in that the temperature (T2) at which the viscosity thereof reaches 10² dPa·s is high and the glass is difficult to melt, and is therefore disadvantageous in point of the energy cost necessary for clarifying and producing a glass melt, or the like. Accordingly, for lowering T2, there may be a means of increasing an alkali metal, increasing an alkaline earth metal or the like, but such a means, when employed, results in an increase in the coefficient of thermal expansion (CTE) to cause other problems of thermal shock resistance degradation, thermal warping and thermal deformation.

To that effect, an aluminosilicate glass could have an increased strength but has a problem that the melting temperature rises or CTE increases.

Accordingly, an object of the present invention is to provide a glass for chemical strengthening and a chemically strengthened glass and a method for producing a chemically strengthened glass, in which strengthening can be more readily introduced than in an ordinary soda lime glass in chemical strengthening, and which can solve the problem of an aluminosilicate that is difficult to melt and the problem thereof whose CTE increases.

### Solution to Problem

The present inventors have found that the above-mentioned problems can be solved by a glass having a specific composition, and have completed the present invention.

Specifically, the present invention is as follows.

1. A glass for chemical strengthening that is a glass sheet containing, as expressed by mass percentage based on oxides, 63 to 75% of SiO₂, 3 to 12% of Al₂O₃, 3 to 10% of MgO, 0.5 to 10% of CaO, 0 to 3% of SrO, 0 to 3% of BaO, 10 to 18% of Na₂O, 0 to 8% of K₂O, 0 to 3% of ZrO₂, and 0.005 to 0.25% of Fe₂O₃, and having a temperature (T2) at which a viscosity thereof reaches 10² dPa·s of 1525° C. or lower, in which R₂O/Al₂O₃ is 2.0 or more and 4.6 or less (in the formula, the R₂O is Na₂O+K₂O).

2. The glass for chemical strengthening according to the above item 1, containing 1% or more of CaO.

3. The glass for chemical strengthening according to the above item 1 or 2, in which the R₂O/Al₂O₃ is 2.4 or more.

4. The glass for chemical strengthening according to any one of the above items 1 to 3, in which the R₂O is 10 to 18%.

5. The glass for chemical strengthening according to any one of the above items 1 to 4, in which Al₂O₃ is 4% or more, MgO is 3.5% or more, CaO is 5% or more, and BaO is 1% or less.

6. The glass for chemical strengthening according to any one of the above items 1 to 4, in which CaO is less than 5%, BaO is 1% or less and the R₂O/Al₂O₃ is 3.2 or less.

7. The glass for chemical strengthening according to any one of the above items 1 to 6, in which K₂O is 2% or less.

8. The glass for chemical strengthening according to any one of the above items 1 to 7, further containing, as expressed by mass percentage based on an oxide, 1% or less of B₂O₃.

9. The glass for chemical strengthening according to any one of the above items 1 to 8, further containing, as expressed by mass percentage based on an oxide, 0.2% or less of TiO₂.

10. The glass for chemical strengthening according to any one of the above items 1 to 9, in which the T2 is 1510° C. or lower.

11. The glass for chemical strengthening according to any one of the above items 1 to 10, having a glass transition point (Tg) of 530° C. or higher.

12. The glass for chemical strengthening according to any one of the above items 1 to 11, having a mean linear thermal expansion coefficient at 50 to 350° C. of 100 x 10⁻⁷° C⁻¹ or less.

13. The glass for chemical strengthening according to any one of the above items 1 to 12, having a devitrification temperature of not higher than a temperature (T4) at which the viscosity thereof reaches 10⁴ dPa·s.

14. The glass for chemical strengthening according to any one of the above items 1 to 13, in which the glass sheet is formed according to a float process.

15. A chemically strengthened glass obtained by chemically strengthening the glass for chemical strengthening of any one of the above items 1 to 14.

16. The chemically strengthened glass according to the above 15, having a surface compressive stress of 580 MPa or more and a depth of compressive stress of 5 μm or more and 30 μm or less.

17. A method for producing a chemically strengthened glass, including a chemical strengthening step of subjecting the glass for chemical strengthening of any one of the above items 1 to 16 to an ion-exchange treatment.

18. A glass that is a glass sheet containing, as expressed by mass percentage based on oxides, 63 to 75% of SiO₂, 3 to 12% of Al₂O₃, 3 to 10% of MgO, 0.5 to 10% of CaO, 0 to 3% of SrO, 0 to 3% of BaO, 10 to 18% of Na₂O, 0 to 8% of K₂O, 0 to 3% of ZrO₂, and 0.005 to 0.25% of Fe₂O₃, having a temperature (T2) at which a viscosity thereof reaches 10² dPa·s of 1525° C. or lower, in which R₂O/Al₂O₃ is 2.0 or more and 4.6 or less (in the formula, the R₂O is Na₂O+K₂O).

19. The glass according to the above item 18, containing 1% or more of CaO.

20. The glass according to the above item 18 or 19, in which the R₂O/Al₂O₃ is 2.4 or more.

21. The glass according to any one of the above items 18 to 20, in which the R₂O is 10 to 18%.

22. The glass according to any one of the above items 18 to 21, in which Al₂O₃ is 4% or more, MgO is 3.5% or more, CaO is 5% or more, and BaO is 1% or less.

23. The glass according to any one of the above items 18 to 21, in which CaO is less than 5%, BaO is 1% or less and the R₂O/Al₂O₃ is 3.2 or less.

24. The glass according to any one of the above items 18 to 23, in which K₂O is 2% or less.

25. The glass according to any one of the above items 18 to 24, further containing, as expressed by mass percentage based on an oxide, 1% or less of B₂O₃.

26. The glass according to any one of the above items 18 to 25, in which the T2 is 1510° C. or lower.

27. The glass according to any one of the above items 18 to 26, having a devitrification temperature of not higher than a temperature (T4) at which the viscosity thereof reaches 10⁴ dPa·s.

28. The glass according to any one of the above items 18 to 27, further containing, as expressed by mass percentage based on an oxide, 0.2% or less of TiO₂.

29. The glass according to any one of the above items 18 to 28, having a glass transition point (Tg) of 530° C. or higher.

30. The glass according to any one of the above items 18 to 29, having a mean linear thermal expansion coefficient at 50 to 350° C. of 100×10⁻⁷° C⁻¹ or less.

31. The glass according to any one of the above items 18 to 30, formed according to a float process.

32. The glass according to any one of the above items 18 to 31, which is applicable to a chemical strengthening treatment.

33. A chemically strengthened glass obtained by chemically strengthening the glass of the above item 32.

34. The chemically strengthened glass according to the above 33, having a surface compressive stress of 580 MPa or more and a depth of compressive stress of 5 μm or more and 30 μM or less.

35. A method for producing a chemically strengthened glass, including a chemical strengthening step of subjecting the glass of any one of the above items 18 to 26 to an ion-exchange treatment.

### ADVANTAGEOUS EFFECTS OF INVENTION

The glass for chemical strengthening of the present invention has a specific composition, in which, in particular, the contents of Al₂O₃, MgO and CaO as well as (Na₂O+K₂O)/Al₂O₃ each fall within a specific range, and accordingly, it can provide a glass for chemical strengthening and a chemically strengthened glass and a method for producing a chemically strengthened glass, in which strengthening can be more readily introduced than in an ordinary soda lime glass in chemical strengthening, and CTE is low though the glass is more easily melted than an aluminosilicate glass.

### DESCRIPTION OF EMBODIMENTS

One embodiment of the present invention is described below. The glass for chemical strengthening of the present embodiment and the chemically strengthened glass produced by applying chemical strengthening treatment to the glass for chemical strengthening are collectively called the glass of the present embodiment.

The glass for chemical strengthening of the present embodiment is a glass sheet containing, as expressed by mass percentage based on oxides, 63 to 75% of SiO₂, 3 to 12% of Al₂O₃, 3 to 10% of MgO, 0.5 to 10% of CaO, 0 to 3% of SrO, 0 to 3% of BaO, 10 to 18% of Na₂O, 0 to 8% of K₂O, 0 to 3% of ZrO₂, and 0.005 to 0.25% of Fe₂O₃, and having a temperature (T2) at which the viscosity thereof reaches 10² dPa·s of 1525° C. or lower, in which R₂O/Al₂O₃ is 2.0 or more and 4.6 or less (in the formula, the R₂O is Na₂O+K₂O).

The reason why the glass composition of the glass for chemical strengthening of the present embodiment is defined to be within the above-mentioned range is described below.

SiO₂ is known as a component to form a network structure in a glass microstructure, and is a main component to constitute a glass. The content of SiO₂ is 63% or more, preferably 64% or more, more preferably 65% or more, and even more preferably 67% or more. The content of SiO₂ is 75% or less, preferably 73% or less, more preferably 71% or less, and even more preferably 70% or less. When the content of SiO₂ is 63% or more, it is advantageous in point of stability and weather resistance as a glass. In addition, by forming a network structure, an increase in expansion can be inhibited. On the other hand, when the content of SiO₂ is 75% or less, it is advantageous in point of meltability and formability.

Al₂O₃ has an effect of improving ion exchangeability in chemical strengthening, and especially the effect thereof for improving CS is great. It is also known as a component for improving the weather resistance of a glass. In addition, it has an effect of inhibiting invasion of tin from the bottom surface in forming according to a float process. Further, it has an effect of promoting dealkalization in performing SO₂ treatment.

The content of Al₂O₃ is 3% or more, preferably 3.8% or more, more preferably 4% or more, even more preferably 4.5% or more, especially preferably 5% or more, and most preferably 5.5% or more. The content of Al₂O₃ is 12% or less, more preferably 11% or less, even more preferably 10% or less, still more preferably 8% or less, and most preferably 7% or less. When the content of Al₂O₃ is 3% or more, a desired CS value can be obtained through ion exchange, and in a float process, there can be realized the effect of preventing invasion of tin from the surface (bottom surface) kept in contact with a tin melt bath to thereby make the glass hardly warp in chemical strengthening, an effect of stabilizing water content change and an effect of promoting dealkalization. On the other hand, when the content of Al₂O₃ is 12% or less, the devitrification temperature would not rise so greatly even when the viscosity of glass is high, which is therefore advantageous in point of melting and forming in a soda lime glass production line.

MgO is a component for stabilizing a glass and improving the meltability thereof, and when incorporated, it can lower the alkali metal content to prevent CTE increase, and is indispensable. The content of MgO is 3% or more, preferably 3.5% or more, more preferably 4% or more, and even more preferably 5% or more. The content of MgO is 10% or less, preferably 8% or less and more preferably 7% or less. When the content of

MgO is 3% or more, it exhibits the effect of preventing CTE increase. On the other hand, when the content of MgO is 10% or less, the property that devitrification hardly occurs could be maintained or a sufficient ion-exchanging rate could be realized. More preferably, it is 6% or less, even more preferably 5% or less and especially preferably 4.5% or less.

CaO is a component for stabilizing a glass, having an effect of preventing devitrification owing to the existence of MgO and improving the meltability while preventing CTE increase, and is indispensable. The content of CaO is 0.5% or more, preferably 1% or more, even more preferably 3% or more, further more preferably 4% or more, especially preferably 5% or more, and most preferably 6% or more. In turn, the content of CaO is 10% or less, preferably 9% or less and more preferably 8% or less. When the content of CaO is 0.5% or more, the meltability at a high temperature can be bettered and devitrification hardly occurs, and CTE increase can be prevented. On the other hand, when the content of CaO is 10% or less, a sufficient ion-exchanging rate could be attained and a desired DOL could be realized. In the case where the ion exchange performance in chemical strengthening is desired to be specifically increased, the CaO is less than 6.5%, preferably 6% or less, more preferably less than 5%, even more preferably 3% or less, and especially preferably 2.5% or less.

SrO is a component effective for lowering the viscosity and the devitrification temperature of glass, and especially when MgO/CaO is 3 or more, the effect thereof to lower the devitrification temperature is great. However, as compared with that of MgO and CaO, the effect thereof of lowering an ion-exchanging rate is large and therefore it is at most 3%, even when contained.

BaO is a component effective for lowering the viscosity and the devitrification temperature of glass. The content of BaO is 3% or less, preferably 2% or less and more preferably 1% or less. However, among alkaline earth metal oxides, BaO has a highest effect of lowering an ion-exchanging rate, and therefore BaO may be controlled so that it is substantially not contained, or even when contained, the content thereof is at most 3%.

The wording “substantially not contained” as referred to herein means that the component is not contained except unavoidable impurities which may be contained in starting materials and the like, that is, the component is not intentionally contained.

Na₂O is an indispensable component for forming a surface compressive stress layer through ion exchange, and has an effect of increasing DOL. In addition, it is a component for lowering the melting temperature and the devitrification temperature of glass, and improving the meltability and formability of glass. Na₂O is a component of producing non-bridge oxygen (NBO) and decreases the fluctuation of the chemical strengthening characteristics when the water content changes in glass.

The content of Na₂O is 10% or more, preferably 11% or more and more preferably 13% or more. In turn, the content of Na₂O is 18% or less, preferably 17% or less and more preferably 16% or less. When the content of Na₂O is 10% or more, a desired surface compressive stress layer can be formed through ion exchange, and the fluctuation relative to water content change can be suppressed. On the other hand, when the content of Na₂O is 18% or less, sufficient weather resistance can be realized, and in formation according to a float process, tin invasion from the bottom surface can be prevented and thereby the glass can be made to hardly warp after chemical strengthening treatment.

K₂O has an effect of increasing an ion-exchanging rate to increase DOL, and lowering the melting temperature of glass, and this is a component of increasing non-bridge oxygen. Accordingly, it may be contained within a range of 8% or less. When it is 8% or less, DOL does not increase too much, a sufficient CS can be realized, and the melting temperature of glass can be lowered. When K₂O is contained, it is preferably 5% or less, more preferably 4% or less and even more preferably 2% or less. K₂O may increase the reduction in the surface compressive stress in chemical strengthening owing to degradation of the molten salt thereof, and therefore, when degradation of strengthening characteristics are taken into consideration, it is desirable that the component is not substantially contained. When contained, it is preferably limited to 0.4% or less and more preferably 0.3% or less. On the other hand, a small amount of K₂O has an effect of preventing tin invasion from the bottom surface in forming according to the float process, and therefore in forming according to a float process, it is preferably contained. In this case, the content of K₂O is preferably 0.01% or more and more preferably 0.1% or more.

Though not indispensable, ZrO₂ may be contained within a range of up to 3%, for the purpose of lowering the viscosity at a high temperature without raising CTE, for the purpose of increasing the surface compressive stress and for the purpose of improving the acid resistance. When too much ZrO₂ is incorporated, the melting temperature may rather rise, but when it is 3% or less, viscosity increase and devitrification occurrence can be prevented. It is preferably 2% or less and more preferably 1% or less.

Fe₂O₃ absorbs heat in melting glass, and is therefore an indispensable component for improving meltability. The content of Fe₂O₃ is 0.005% or more, preferably 0.008% or more and more preferably 0.01% or more. In turn, the content of Fe₂O₃ is 0.25% or less, preferably 0.2% or less and more preferably 0.15% or less. For preventing the increase in the paver temperature of a furnace, the content of Fe₂O₃ is preferably 0.005% or more. On the other hand, when the content of Fe₂O₃ is 0.25% or less, coloration can be prevented.

The present inventors have found that for realizing a reduction in the melting temperature of an aluminosilicate glass, a reduction in CTE thereof, and an easiness of the strengthening in chemical strengthening compared to a soda lime glass, especially an effect of increasing CS, it is effective to define R₂O/Al₂O₃ to be 2.0 or more and 4.6 or less (in the formula, the R₂O is Na₂O+K₂O).

Al₂O₃ has an effect of increasing CS, but increases the melting temperature. Na₂O has an effect of increasing CS. K₂O has an effect of increasing an ion-exchanging rate to increase DOL. Na₂O and K₂O have an effect of preventing an increase of melting temperature of glass and increasing CTE.

Accordingly, when Al₂O₃, Na₂O and K₂O are contained in a specific ratio, the melting temperature increase can be prevented and CTE increase can be prevented and at the same time, the effect of increasing CS can be enhanced. From these viewpoints, the ratio of (Na₂O+K₂O)/Al₂O₃ is 4.6 or less, preferably 4.2 or less, more preferably 4 or less, even more preferably 3.8 or less, and especially preferably 3.2 or less. The ratio of (Na₂O+K₂O)/Al₂O₃ is 2.0 or more, preferably 2.4 or more, more preferably 2.6 or more, and even more preferably 3.0 or more. When the ratio of (Na₂O+K₂O)/Al₂O₃ is 4.6 or less, CTE can be lowered and CS can be increased. When the ratio of (Na₂O+K₂O)/Al₂O₃ is 2.0 or more, the melting temperature becomes satisfactory.

When the ratio of (Na₂O+K₂O)/Al₂O₃ is not more than a specific value, it means that the amount of Na₂O and K₂O relative to Al₂O₃ is small. The present inventors have found that, from the viewpoint of maintaining the viscosity of the above-mentioned glass, MgO can cover the role of these alkali metals.

In addition, chlorides, fluorides and the like may be suitably incorporated as a clarifying agent in glass melting. The glass of the present embodiment is essentially composed of the above-described components, but may contain any other component within a range not detracting from the object of the present invention. In the case where such components are contained, the total content of such components is preferably 5% or less, more preferably 3% or less and typically 1% or less. Hereinafter the above-mentioned other components will be described exemplarily.

Though not indispensable, TiO₂ exists much in natural raw materials and is known to be a coloring source of yellow. When TiO₂ is contained, it is preferably 0.2% or less.

Though not indispensable, SO₃ is known as a clarifying agent in glass melting. When SO₃ is contained, it is preferably 0.3% or less.

ZnO can improve the meltability of glass at a high temperature, and therefore may be incorporated, for example, in an amount of up to 2%. However, in a production according to a float process, it is reduced in a float bath to cause product defects, and is therefore preferably not substantially contained.

B₂O₃ may be contained within a range of 4% or less for improving the meltability at a high temperature or the strength of the glass. It is preferably 3% or less, more preferably 2% or less and even more preferably 1% or less. In general, when B₂O₃ is contained together with an alkali component of Na₂O or K₂O, evaporation thereof may occur vigorously to greatly corrode bricks. Therefore, it is preferable that B₂O₃ is not substantially contained.

Li₂O is a component that lowers the strain point to facilitate stress relaxation, therefore making it difficult to obtain a stable surface compressive stress layer. Therefore, it is preferably not contained. Even when contained, the content thereof is preferably less than 1%, more preferably 0.05% or less and even more preferably less than 0.01%.

The glass of the present embodiment generally has a tabular form, but may be any of a planar sheet or a bent-processed glass sheet. The glass of the present embodiment is a glass sheet formed in a planar form according to a known glass forming process such as a float process, a fusion process, a slot downdraw process, etc.

The glass for chemical strengthening of the present embodiment has a size that can be formed according to an already-existing forming process. Specifically, when formed according to a float process, a continuous ribbon-shaped glass having a float forming width can be obtained. The glass of the present embodiment is finally cut into a size suitable for the intended use.

Specifically, it may have a size of displays such as tablet PCs, smartphones, etc., or a size of windowpanes of buildings or houses. The glass of the present embodiment is generally cut in a rectangular form, but may also be in any other form such as circular form or polygonal form with no problem, including a perforated glass.

It is reported that a glass formed according to a float process warps after chemical strengthening to lose planarity (for example Japanese Patent No. 2033034). It is said that the warping is caused by the difference in the degree of chemical strengthening between the top surface that is the glass surface not in contact with a molten tin in forming according to a float process and the bottom surface that is the glass surface in contact with the molten tin.

The glass of the present embodiment undergoes little change in chemical strengthening characteristics even when kept in contact with a molten tin and the change in chemical strengthening characteristics owing to difference in the water content thereof is also small, and therefore especially in forming according to a float process, the glass exhibits an effect of reducing the warping thereof in chemical strengthening. Accordingly, the glass of the present embodiment warps little after chemical strengthening treatment even though it is a thin sheet, and in addition, after chemically strengthened, it warps little and can have a high strength.

In the glass formed according to a float process, water vaporizes out from the top surface thereof, and therefore the water content in the top surface differs from that in the bottom surface. When the ratio of Na₂O, K₂O and Al₂O₃ is defined to fall within the above-mentioned range, it may also be possible to reduce the warping of glass after chemical strengthening to be caused by water content change.

In addition, as a means for reducing the warping of glass after chemical strengthening, it is also effective to control the alkali concentration in the surface layer. Concretely, the surface layer of the top surface is dealkalized to lower the ion-exchangeability of the top surface whereby the stress in the top surface generated in chemical strengthening is balanced with the stress in the bottom surface to reduce the warping.

As a means of dealkalization, it is effective to treat the surface layer of the top surface with at least one acid gas selected from SO₂ gas, HCl gas, HF gas, and the like, or a mixed gas containing at least one acid gas selected from these. The present inventors have found that by increasing the content of Al₂O₃, the dealkalization by SO₂ treatment can be effectively promoted.

It is considered that this is because an increase of Al in a glass broadens the gap in the network structure of the glass by which ion exchange between Na⁺ and H⁺ could be promoted. When the content of Al₂O₃ is 3% or more, the dealkalization treatment by SO₂ gas can be effectively promoted to readily control the warping of the glass after chemical strengthening.

The thickness of a glass sheet may vary by 3 times or more depending on the use thereof, and therefore in discussing the values of CS and DOL, it is preferable that the thickness of the glass sheet is defined, and it is preferably 0.1 mm or more, more preferably 0.2 mm or more and even more preferably 0.3 mm or more. In general, it is 3 mm or less, preferably 2 mm or less, more preferably 1.5 mm or less, even more preferably 1.3 mm or less, and especially preferably 1.1 mm or less.

When the thickness is 0.1 mm or more, a more sufficient effect for strength improvement can be realized through chemical strengthening treatment. In turn, a glass sheet having a thickness of 3 mm or more can easily processed for physical strengthening treatment, and therefore glass having a high necessity for chemical strengthening treatment is one having a thickness of 3 mm or less. On the other hand, for the reason of such as improving cuttability after chemical strengthening, even a glass having a thickness of 3 mm or more may be preferred to be processed for chemical strengthening to provide a compressive stress layer having a short depth but not for physical strengthening to provide a compressive stress layer having a large depth.

For example, in a most preferred case of the present embodiment of a glass sheet having a thickness of 0.7 mm or 1.1 mm, the value of CS of the chemically strengthened glass is generally 550 MPa or more, preferably 580 MPa or more, more preferably 600 MPa or more, and even more preferably 650 MPa or more. For enabling cutting after chemical strengthening treatment, it is preferably 900 MPa or less and more preferably 850 MPa or less. Control of CS may be enabled by controlling the Na concentration in the molten potassium nitrate salt for use in ion exchange, the strengthening time and the temperature of the molten salt. For realizing a higher CS, the Na concentration is reduced. Specifically, the Na concentration is preferably 3 wt % or less, more preferably 2.5 wt % or less and even more preferably 1 wt % or less.

The value of DOL of the chemically strengthened glass of the present embodiment is preferably 5 μm or more and more preferably 7 μm or more. In particular, when influenced by scratches during handling of the glass, it is preferably 10 μm or more. For enabling cutting after chemical strengthening treatment, it is preferably 30 μm or less, more preferably 25 μm or less and even more preferably 20 μm or less. Control of DOL may be enabled by controlling the Na concentration in the molten potassium nitrate salt for use in ion exchange, the strengthening time and the temperature of the molten salt. For realizing a higher DOL, the temperature of the molten salt is increased. Specifically, the temperature of the molten potassium nitrate salt is preferably 400° C. or higher, more preferably 420° C. or higher and even more preferably 430° C. or higher.

The glass of the present embodiment is characterized in that it can be readily converted from an ordinary soda lime glass in point of both the production characteristics and the product characteristics. Regarding an ordinary soda lime glass, the temperature (T2) at which the viscosity thereof that is a basis in melting the glass reaches 10² dPa·s is generally 1445 to 1475° C.

In melting, when the increase in T2 is within a range of up to about +50° C., the glass of the present embodiment can be readily produced in a production furnace where an ordinary soda lime glass is melted. T2 in melting the glass of the present embodiment is 1525° C. or lower, preferably 1510° C. or lower, more preferably 1500° C. or lower, and even more preferably 1490° C. or lower. In turn, T2 is preferably 1450° C. or higher. When T2 is 1525° C. or lower, the problem that a conventional aluminosilicate glass is difficult to melt can be solved.

Control of T2 may be enabled by, for example, controlling the difference between the total amount of SiO₂ and Al₂O₃ and the total content of R₂O and RO (in the formula, the RO is MgO, CaO, SrO, and BaO), that is, by controlling the NBO amount.

Regarding an ordinary soda lime glass, the temperature (T4) at which the viscosity thereof that is a basis in forming the glass according to a float process reaches 10⁴ dPa·s is generally 1020 to 1050° C. When the increase in the temperature T4 to realize that viscosity is within a range of up to about +30° C., the glass of the present embodiment can be readily produced in a production furnace where an ordinary soda lime glass is formed. T4 in forming the glass of the present embodiment is preferably 1080° C. or lower, more preferably 1070° C. or lower and even more preferably 1060° C. or lower.

In producing a glass according to a float process, the devitrification temperature relates to the risk of devitrification occurrence relative to the above-mentioned T4. In general, when a glass has the devitrification temperature of not higher than the temperature higher by 15° C. than T4, it can be produced without an occurrence of devitrification in a float process, and preferably it is equal to or less than T4, more preferably equal to or less than a temperature lower by 10° C. than T4, even more preferably equal to or less than a temperature lower by 20° C. than T4, and most preferably equal to or less than a temperature lower by 30° C. than T4.

The devitrification temperature in the present embodiment is determined as follows. Ground glass particles are put on a platinum dish, and heated for 17 hours in an electric furnace controlled at a constant temperature, and after the heat treatment, they are observed with an optical microscope. The highest temperature at which crystals are deposited in the surface and the inside of the glass and the lowest temperature at which crystals are not deposited are averaged to give the average value as the devitrification temperature.

The glass transition point (Tg) of the glass of the present embodiment is, for example, 530° C. or higher, preferably 540° C. or higher, more preferably 550° C. or higher, and even more preferably 550 to 600° C. When Tg is 530° C. or higher, it is advantageous in point of preventing stress relaxation, preventing thermal warping and the like in chemical strengthening treatment. Control of Tg may be enabled by, for example, controlling the total amount of SiO₂ and Al₂O₃ and the amount of R₂O and RO.

CTE of the glass of the present embodiment is, in a temperature range of 50 to 350° C., for example, 80 to 100×10⁻⁷° C⁻¹, preferably 82 to 98×10⁻⁷° C., more preferably 84 to 97×10⁻⁷° C., and even more preferably 85 to 95×10⁻⁷° C⁻¹. When CTE is 80×10⁻⁷° C.⁻¹or more, the glass is advantageous in point of matching of the thermal expansion coefficient thereof with that of metals and other substances. When CTE is 100×10⁻⁷° C⁻¹ or less, it is advantageous in point of thermal impact resistance, warping characteristics, etc. Control of CTE may be enabled by, for example, controlling the amount of R₂O and RO. For attaining a preferred CTE, the amount of R₂O is preferably 10 to 18% by mass, more preferably 12 to 17% by mass and even more preferably 13 to 16% by mass.

Glass for displays is formed into products for information instruments and others via various steps of film formation, lamination, etc., and therefore it is desired that CTE would not greatly fluctuate from a conventional value. CTE of an ordinary soda lime glass is generally 85×10⁻⁷ to 93×10⁻⁷° C.⁻¹ within a temperature range of 50 to 350° C., and CTE of the glass of the present embodiment preferably falls within the range.

The specific gravity at room temperature of an ordinary soda lime glass is 2.490 to 2.505. In consideration of a case where the glass of the present embodiment and an ordinary soda lime glass are alternately produced in the same furnace, when the specific gravity fluctuation is 0.01 or less, the composition change is easy. The specific gravity of the glass of the present embodiment is preferably 2.480 or more and 2.515 or less.

Regarding the temperature for performing chemical strengthening treatment, an effective treatment temperature may be determined on the basis of the strain point of glass. In general, chemical strengthening treatment is carried out at a temperature lower than the strain point by 50 to 100° C. The strain point of an ordinary soda lime glass is 490 to 520° C.

For applying the same chemical strengthening treatment as a conventional one to the glass of the present embodiment, the strain point thereof is preferably 480 to 540° C. and more preferably 490 to 530° C. A highly skilled technique is necessary for strain point measurement, and therefore, the thermal expansion coefficient is measured to determine the glass transition temperature Tg, and this may be used as a substitute. In general, Tg is higher temperature by about 40° C. than the strain point.

By being subjected to an ordinary chemical strengthening treatment that has heretofore been applied to an ordinary soda lime glass, the glass of the present embodiment can give a chemically strengthened glass having a higher strength. For example, it may be chemically strengthened by immersing it in a molten potassium nitrate salt at 410 to 470° C. for 1 to 24 hours.

The glass of the present embodiment can be cut after chemical strengthening treatment. Regarding the cutting method, scribing and braking with an ordinary wheel chip cutter is applicable, and cutting with a laser is also applicable. For maintaining the glass strength, chamfering of the cut edges may be performed after the cutting. The chamfering may be a mechanical grinding process, or a method of processing with a chemical of hydrofluoric acid or the like may also be employed.

### EXAMPLES

Hereinunder the present invention is described further with reference to Examples and Comparative Examples, but the present invention is not limited to the following Examples.

### [Evaluation Methods]

### (1) Specific Gravity

The specific gravity was measured according to an Archimedes' method.

### (2) CTE, Glass Transition Point (Tg)

Regarding CTE, at the same time of a measurement of the glass transition point (Tg), the sample was analyzed on the basis of JIS R 1618:2002 at a temperature rising rate of 5° C./min by using a thermal dilatometer (manufactured by Bruker AXS K.K., TD5000SA), and the mean linear thermal expansion coefficient thereof at 50 to 350° C. was determined.

### (3) Surface Compressive Stress (CS) and Depth of Compressive Stress Layer (DOL)

The surface compressive stress and the depth of the compressive stress layer were measured with a surface stress meter manufactured by Orihara Manufacturing Co., Ltd., FSM-6000.

### (4) High-Temperature Viscosity

The temperature (T2) at which the viscosity reaches 10² dPa·s and the temperature (T4) at which the viscosity reaches 10⁴ dPa·s were measured by using a rotational viscometer.

### Examples 1 to 24, Comparative Examples 1 to 3

Glass raw materials that are widely used, such as silica sand, soda ash, dolomite, feldspar, mirabilite, and other oxides, carbonates, and hydroxides were suitably selected and weighed to be 1 kg in terms of glass and to have a composition as expressed by mass percentage based on oxides as shown in Tables 1 to 3 below. The amount of mirabilite put into the device was 2 times the amount equivalent to SO₃. The weighed raw materials were mixed and put into a platinum crucible, set in a resistance heating electric furnace at 1480° C., melted for 3 hours, defoamed, and homogenized.

The resultant molten glass was cast into a mold, kept therein at a temperature of Tg+50° C. for 1 hour, followed by cooling to room temperature at a rate of 0.5° C./min to prepare a few glass blocks. For samples to be processed for chemical strengthening treatment, the glass block was cut, polished and finally mirror-finished on both surfaces thereof to give a glass sheet having a size of 30 mm×30 mm and a thickness of 1.0 mm. The specific gravity, CTE, Tg, T2, and T4 of this glass sheet were measured. The results are shown in Tables 1 to 3. The values in parentheses are calculated values.

In a laboratory, the glasses shown in Tables 1 to 3 below were immersed in a mixed salt (potassium nitrate 97.8 wt %+sodium nitrate 2.2 wt %) at 425° C. for 150 minutes for performing chemical strengthening treatment thereto. After the chemical strengthening treatment, each glass was analyzed for the surface compressive stress CS (unit: MPa) and the depth of the compressive stress layer DOL (unit: μm), with a surface stress meter manufactured by Orihara Manufacturing Co., Ltd., FSM-6000. The results are shown in Tables 1 to 3. The values in parentheses are estimated values.

TABLE 1

| | | Com. | Com. | Com. | | | | | | | |
|---|---|---|---|---|---|---|---|---|---|---|---|
| | | Ex. 1 | Ex. 2 | Ex. 3 | Ex. 1 | Ex. 2 | Ex. 3 | Ex. 4 | Ex. 5 | Ex. 6 | Ex. 7 |
| Mass % | SiO₂ | 70.21 | 61.40 | 71.8 | 68.33 | 69.49 | 70.97 | 69.49 | 69.92 | 70.07 | 69.31 |
| | Al₂O₃ | 8.87 | 8.50 | 1.89 | 5.00 | 4.50 | 3.62 | 4.50 | 3.57 | 4.04 | 3.73 |
| | MgO | 5.18 | 7.80 | 4.62 | 4.13 | 4.49 | 4.84 | 3.98 | 4.64 | 5.03 | 5.22 |
| | CaO | 0.44 | 0.60 | 7.8 | 7.00 | 7.50 | 7.25 | 8.01 | 7.61 | 8.18 | 6.83 |
| | SrO | 0.00 | 1.60 | 0.00 | 0.00 | 0.00 | 0.00 | 0.00 | 0.00 | 0.00 | 0.18 |
| | BaO | 0.00 | 0.00 | 0.00 | 0.00 | 0.00 | 0.00 | 0.00 | 0.00 | 0.00 | 0.00 |
| | ZrO₂ | 0.02 | 0.00 | 0.00 | 0.00 | 0.00 | 0.00 | 0.00 | 0.56 | 0.60 | 0.62 |
| | Na₂O | 13.43 | 17.00 | 13.3 | 15.00 | 13.50 | 13.10 | 13.5 | 12.87 | 11.28 | 13.77 |
| | K₂O | 1.67 | 3.20 | 0.31 | 0.12 | 0.11 | 0.05 | 0.11 | 0.56 | 0.54 | 0.10 |
| | TiO₂ | 0.00 | 0.00 | 0.03 | 0.10 | 0.10 | 0.02 | 0.10 | 0.06 | 0.06 | 0.04 |
| | Fe₂O₃ | 0.01 | 0.00 | 0.00 | 0.11 | 0.11 | 0.01 | 0.109 | 0.01 | 0.01 | 0.01 |
| | SO₃ | 0.00 | 0.00 | 0.25 | 0.20 | 0.20 | 0.15 | 0.20 | 0.20 | 0.20 | 0.20 |
| | R₂O/Al₂O₃ | 1.70 | 2.38 | 7.20 | 3.02 | 3.02 | 3.63 | 3.02 | 3.76 | 2.92 | 3.72 |
| | R₂O | 15.10 | 20.20 | 13.61 | 15.12 | 13.61 | 13.15 | 13.61 | 13.43 | 11.82 | 13.87 |
| CS | MPa | 572 | 573 | 542 | 669 | 633 | 608 | | 595 | 611 | 649 |
| DOL | μm | 33 | 35 | 6 | 9 | 7 | 6 | | 7 | 6 | 7 |
| T2 | ° C. | 1669 | 1479 | 1447 | 1455 | 1471 | | | 1490 | 1502 | 1474 |
| T4 | ° C. | 1180 | 1045 | 1039 | 1042 | 1058 | | | 1072 | 1090 | 1061 |
| Devitrification | ° C. | | | | 1015 | | 1065 | 1045 | | | |
| Temperature | | | | | | | | | | | |
| Tg | ° C. | 576 | 536 | 557 | 556 | 568 | 567 | 567 | 565.4 | 589.6 | 567.1 |
| CTE | ×10⁻⁷/° C. | 83 | 109 | | 92 | 87 | 85 | 88 | 86.63 | 81.5 | 87.73 |
| Specific | | 2.43 | 2.52 | 2.4927 | 2.5009 | 2.4984 | 2.4883 | 2.4998 | 2.5044 | 2.5172 | 2.5053 |
| Gravity | | | | | | | | | | | |

TABLE 2

| | | Ex. 8 | Ex. 9 | Ex. 10 | Ex. 11 | Ex. 12 |
|---|---|---|---|---|---|---|
| Mass % | SiO₂ | 65.6 | 64.3 | 64.1 | 66.8 | 67.2 |
| | Al₂O₃ | 5.3 | 7.8 | 7.8 | 5.6 | 7.5 |
| | MgO | 9.4 | 5.5 | 5.6 | 7.3 | 5.5 |
| | CaO | 1.0 | 2.6 | 2.3 | 1.0 | 3.5 |
| | SrO | 0.0 | 0.0 | 0.3 | 0.0 | 0.0 |
| | BaO | 0.0 | 0.0 | 0.0 | 0.0 | 0.0 |
| | ZrO₂ | 1.9 | 2.0 | 2.0 | 2.7 | 0.0 |
| | Na₂O | 16.8 | 15.8 | 15.9 | 16.6 | 16.2 |
| | K₂O | 0.0 | 2.0 | 2.0 | 0.0 | 0.0 |
| | Fe₂O₃ | 0.01 | 0.01 | 0.01 | 0.01 | 0.01 |
| | SO₃ | 0.03 | 0.03 | 0.03 | 0.03 | 0.03 |
| | R₂O/Al₂O₃ | 3.18 | 2.28 | 2.30 | 2.93 | 2.15 |
| | R₂O | 16.77 | 17.84 | 17.92 | 16.55 | 16.19 |
| CS | MPa | 844 | 771 | 745 | 800 | 749 |
| DOL | μm | 12 | 18 | 19 | 16 | 14 |
| T2 | ° C. | (1456) | (1496) | (1493) | 1501 | 1505 |
| T4 | ° C. | (1069) | (1086) | (1084) | 1100 | 1080 |
| Devitrification | ° C. | 1030 | 970 | 970 | 960 | 1010 |
| Temperature | | | | | | |
| Tg | ° C. | 583 | 563 | 563 | 582 | 567 |
| CTE | ×10⁻⁷/° C. | 91 | 101 | 97 | 91 | 93 |
| Specific | | 2.506 | 2.512 | 2.514 | 2.496 | 2.478 |
| Gravity | | | | | | |

| | | Ex. 13 | Ex. 14 | Ex. 15 | Ex. 16 | Ex. 17 |
|---|---|---|---|---|---|---|
| Mass % | SiO₂ | 68.1 | 67.9 | 68.5 | 67.0 | 67.0 |
| | Al₂O₃ | 6.7 | 5.9 | 5.9 | 6.9 | 7.4 |
| | MgO | 6.7 | 8.0 | 8.0 | 8.0 | 8.0 |
| | CaO | 2.9 | 2.0 | 2.0 | 2.0 | 2.0 |
| | SrO | 0.0 | 0.0 | 0.0 | 0.0 | 0.0 |
| | BaO | 0.0 | 0.0 | 0.0 | 0.0 | 0.0 |
| | ZrO₂ | 0.0 | 0.0 | 0.0 | 0.0 | 0.0 |
| | Na₂O | 15.7 | 16.1 | 15.6 | 16.1 | 15.6 |
| | K₂O | 0.0 | 0.0 | 0.0 | 0.0 | 0.0 |
| | Fe₂O₃ | 0.01 | 0.010 | 0.01 | 0.01 | 0.01 |
| | SO₃ | 0.03 | 0.03 | 0.03 | 0.03 | 0.03 |
| | R₂O/Al₂O₃ | 2.36 | 2.76 | 2.64 | 2.33 | 2.11 |
| | R₂O | 15.70 | 16.14 | 15.60 | 16.10 | 15.60 |
| CS | MPa | 751 | 743 | 758 | 779 | 794 |
| DOL | μm | 14 | 14 | 14 | 14 | 13 |
| T2 | ° C. | 1507 | 1472 | (1496) | 1496 | 1504 |
| T4 | ° C. | 1084 | 1061 | (1080) | 1086 | 1091 |
| Devitrification | ° C. | 1030 | 980 | 1030 | 1030 | 1050 |
| Temperature | | | | | | |
| Tg | ° C. | 574 | 570 | 572 | 578 | 584 |
| CTE | ×10⁻⁷/° C. | 90 | 93 | 91 | 90 | 90 |
| Specific | | 2.469 | 2.468 | 2.463 | 2.474 | 2.474 |
| Gravity | | | | | | |

TABLE 3

| | | Ex. 18 | Ex. 19 | Ex. 20 | Ex. 21 | Ex. 22 | Ex. 23 | Ex. 24 |
|---|---|---|---|---|---|---|---|---|
| Mass % | SiO₂ | 68.0 | 67.8 | 67.7 | 67.4 | 68.2 | 66.7 | 67.0 |
| | Al₂O₃ | 5.9 | 5.9 | 5.9 | 5.9 | 4.4 | 5.8 | 5.8 |
| | MgO | 9.0 | 8.2 | 7.7 | 6.7 | 7.7 | 3.8 | 5.3 |
| | CaO | 1.0 | 2.0 | 2.7 | 4.0 | 3.6 | 8.0 | 6.0 |
| | SrO | 0.0 | 0.0 | 0.0 | 0.0 | 0.0 | 0.0 | 0.0 |
| | BaO | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 |
| | Na₂O | 16.1 | 16.1 | 16.0 | 16.0 | 14.6 | 15.8 | 15.9 |
| | K₂O | 0.0 | 0.0 | 0.0 | 0.0 | 1.0 | 0.0 | 0.0 |
| | Fe₂O₃ | 0.01 | 0.01 | 0.01 | 0.01 | 0.01 | 0.01 | 0.01 |
| | SO₃ | 0.03 | 0.03 | 0.03 | 0.03 | 0.03 | 0.03 | 0.03 |
| | R₂O/Al₂O₃ | 2.73 | 2.73 | 2.73 | 2.73 | 3.55 | 2.73 | 2.73 |
| | R₂O | 16.10 | 16.05 | 16.02 | 15.96 | 15.62 | 15.79 | 15.87 |
| CS | MPa | 761 | (742) | (738) | (730) | | (707) | (719) |
| DOL | μm | 15 | (13.3) | (12.6) | (11.3) | | (7.3) | (9.2) |
| T2 | ° C. | 1492 | (1480) | (1475) | (1464) | 1488 | (1434) | (1449) |
| T4 | ° C. | 1085 | (1069) | (1064) | (1055) | 1057 | (1028) | (1042) |
| Devitrification | ° C. | 1030 | | | | 1060 | | |
| Temperature | | | | | | | | |
| Tg | ° C. | 580 | (571) | (569) | (566) | 556 | (557) | (561) |
| CTE | ×10⁻⁷/° C. | 93 | (91.6) | (92.1) | (93.3) | 93 | (96.6) | (95.0) |
| Specific | | 2.460 | 2.470 | 2.476 | 2.488 | 2.482 | 2.524 | 2.506 |
| Gravity | | | | | | | | |

It has been found that, in the glass for chemical strengthening of the present invention prepared in each Example, in particular, the contents of Al₂O₃, MgO and CaO, and (Na₂O+K₂O)/Al₂O₃ are within a specific range, and therefore T2 is low and CTE is prevented from increasing, and the value of CS can be effectively increased through chemical strengthening treatment.

As opposed to this, in the glass for chemical strengthening of Comparative Example 1, (Na₂O+K₂O)/Al₂O₃ is less than 2.0. Consequently, in Comparative Example 1, T2 is 1669° C. and is high, and the solubility worsens. On the other hand, in

Comparative Example 2, SiO₂ is 63% or less and T2 is low, but CTE increases to 109 x 10⁻⁷° C.⁻¹. In the glass for chemical strengthening of Comparative Example 3, Al₂O₃ is less than 3%, and (Na₂O+K₂O)/Al₂O₃ is more than 4.6. Consequently, in Comparative Example 3, CS is low.

While the present invention has been described in detail and with reference to specific embodiments thereof, it will be apparent to one skilled in the art that various changes and modifications can be made therein without departing from the spirit and scope of the present invention.

The present application is based on Japanese Patent Application (Application No.

2013-258465) filed on Dec. 13, 2013, Japanese Patent Application (Application No. 2014-022725) filed on Feb. 7, 2014 and Japanese Patent Application (Application No. 2014-070099) filed on Mar. 28, 2014, and the entire thereof is incorporated herein by reference.

### INDUSTRIAL APPLICABILITY

The chemically strengthened glass of the present invention obtained by chemically strengthening the glass for chemical strengthening of the present invention can be used for a cover glass and a touch sensor glass of a touch panel display equipped in information instruments such as tablet PCs, notebook-size PCs, smartphones, e-book readers, etc., a cover glass of liquid-crystal televisions, PC monitors, etc., a cover glass for solar cells, and a multilayer glass for use in windows of buildings and houses.

1. A glass that is a glass sheet comprising, as expressed by mass percentage based on oxides, 63 to 75% of SiO₂, 3 to 12% of Al₂O₃, 3 to 10% of MgO, 0.5 to 10% of CaO, 0 to 3% of SrO, 0 to 3% of BaO, 10 to 18% of Na₂O, 0 to 8% of K₂O, 0 to 3% of ZrO₂, and 0.005 to 0.25% of Fe₂O₃, having a temperature (T2) at which a viscosity thereof reaches 10² dPa·s of 1525° C. or lower, wherein R₂O/Al₂O₃ is 2.0 or more and 4.6 or less (in the formula, the R₂O is Na₂O+K₂O).

2. The glass according to claim 1, comprising 1% or more of CaO.

3. The glass according to claim 1, wherein the R₂O/Al₂O₃ is 2.4 or more.

4. The glass according to claim 1, wherein the R₂O is 10 to 18%.

5. The glass according to claim 1, wherein Al₂O₃ is 4% or more, MgO is 3.5% or more, CaO is 5% or more, and BaO is 1% or less.

6. The glass according to claim 1, wherein CaO is less than 5%, BaO is 1% or less and the R₂O/Al₂O₃ is 3.2 or less.

7. The glass according to claim 1, wherein K₂O is 2% or less.

8. The glass according to claim 1, further comprising, as expressed by mass percentage based on an oxide, 1% or less of B₂O₃.

9. The glass according to claim 1, wherein the T2 is 1510° C. or lower.

10. The glass according to claim 1, having a devitrification temperature of not higher than a temperature (T4) at which the viscosity thereof reaches 10⁴ dPa·s.

11. The glass according to claim 1, further comprising, as expressed by mass percentage based on an oxide, 0.2% or less of TiO₂.

12. The glass according to claim 1, having a glass transition point (Tg) of 530° C. or higher.

13. The glass according to claim 1, having a mean linear thermal expansion coefficient at 50 to 350° C. of 100×10⁻⁷° C.⁻¹ or less.

14. The glass according to claim 1, formed according to a float process.

15. The glass according to claim 1, which is applicable to a chemical strengthening treatment.

16. A chemically strengthened glass obtained by chemically strengthening the glass of claim 15.

17. The chemically strengthened glass according to claim 16, having a surface compressive stress of 580 MPa or more and a depth of compressive stress of 5 μm or more and 30 μm or less.

18. A method for producing a chemically strengthened glass, comprising a chemical strengthening step of subjecting the glass of claim 1 to an ion-exchange treatment.
